(19) United States
(12) Patent Application Publication
(10) Pub. No.: US 2018/0361668 A1
(43) Pub. Date: Dec. 20, 2018

(54) SCALABLE MULTIPLE-MATERIAL ADDITIVE MANUFACTURING

(71) Applicant: Interlog Corporation, Anaheim, CA (US)

(72) Inventors: Nathanael Kim, Seoul (KR); Justin Kwon, Seoul (KR)

(73) Assignee: Interlog Corporation, Anaheim, CA (US)

(21) Appl. No.: 16/011,588

(22) Filed: Jun. 18, 2018

Related U.S. Application Data
(60) Provisional application No. 62/521,286, filed on Jun. 16, 2017.

(51) Int. Cl. B29C 64/336; B29C 64/295; B29C 64/393; B29C 35/02; B29C 64/209; B29C 37/02

(52) U.S. Cl. CPC B29C 64/336; B29C 64/295; B29C 64/393; B33Y 10/00; B29C 64/209; B29C 37/02; B29C 35/0261

(57) ABSTRACT

A system for scalable multiple-material additive manufacturing (SMAM) includes: an on-demand multiple material manufacturing (M3) unit configured to additively print a designed object, the M3 unit comprising a multi-functional ensemble head configured for multiple material printing, in-line metrology, in-line error corrective milling, and in-line quality inspection; a process control unit configured to autonomously control all functions of the system with remote operation interfaces; an expandable post-processing unit configured to perform heat treatment and polishing/deburring, following the printing; an environmental control unit including an oxygen removal system and particulate filters for additive manufacturing and post-processing; a protective housing providing structural stability and vibration isolation with power and electrical interfaces; a printing head assembly comprising a plurality of printing heads with a multiple feeding mechanism; a laser scanning metrology to monitor dimension discrepancy within a tolerance; and an in-line ultrasonic nondestructive evaluation (NDE) inspection configured to find interfacial defects during the printing.

### CROSS REFERENCE TO RELATED APPLICATIONS

Pursuant to 35 U.S.C. § 119(e), this application claims the benefit of earlier filing date and right of priority to Provisional Application No. 62/521,286 filed on Jun. 16, 2017, the contents of which are hereby incorporated by reference herein in their entirety.

### BACKGROUND

### Technical Field

The present application relates to a three-dimensional (3D) printing technology or additive manufacturing (AM) technology for providing customizable and available-on-demand supplies. Specifically, the present application relates to a hybrid 3D printing technology for seamless AM of desired objects, from microsized to macrosized, that may require multiple material classes such as metals, ceramics, and polymers on a single platform.

### Background

Additive Manufacturing (AM) or 3D printing, in contrast to traditional subtractive technology (lathe, milling) from a solid block, is a method to build 3D objects by adding layer-upon-layer of material, whether the adding material is plastic, metal, concrete or biological tissue. Common to AM technologies is the use of a computer, 3D modeling software (Computer Aided Design or CAD), AM machine platform with auxiliary systems, and layering material. The AM machine platform reads data from the CAD file and lays down or adds successive layers of liquid, powder, sheet material or other types of material, in a layer-upon-layer fashion to fabricate a 3D object.

Typical AM processes include fused deposition modeling (FDM) by heat, selective laser sintering (SLS) or selective laser melting (SLM), Electron Beam Melting (EBM), Electrical Discharge Machining (EDM), binding jet, multi-jet printing, etc. that are based on direct bonding energy application by heating/melting or curing (photo polymerization) materials to bond. Ultrasonic Consolidation (UC) is a combination of additive- and subtractive-process where sheets (or strips) of metal foils are first ultrasonically welded into a stack with a high normal force (greater than 1000 newton). A cutting or milling operation is then used to shape the metal stack into a desired layer shape. As a variation, UC embeds a continuous wire or strip between layers to build an embedded material.

Currently, a state-of-the-art 3D AM is limited to a single material class and a build size, and thus, is not capable of bonding dissimilar materials for hybrid components/structures such as copper to epoxy glass, metals to glass. Especially, printing a microsized, metallic part, less than a cm or mm, is not well studied.

Build failure during the AM process is also common. For example, the SLM/SLS/EDM creates extreme thermal gradients, and the net effect is that stresses are built into the part layer by layer, causing defective builds. When metallic powder is used as feedstock, an inert atmosphere is required because heated fine metal powder can quickly oxidize in an uncontrolled manner, i.e. explode, thus requiring an airtight enclosure and a steady supply of an inert gas like argon. Therefore, improved systems and methods for additive manufacturing, which enable building of composite equipment/supplies on a single platform, are desired.

Build complexity problems in all AM technologies, such as overhangs or protrusions and bridges, are common. Typically, the overhangs are addressed by using additional support structures (raft, brim, etc.). However, removal of such supports after build completion is not easy, and it creates an added, troublesome process in AM methods. UC is inherently difficult for adding and removing such supporting structures.

Part removal performed after printing is finished is usually an additional cumbersome and manual process in the current AM technologies. To remove a part, the machine must mill or cut a finished build from a base substrate or plate, thus requiring additional post-processing dimension check and replenishing base platen blocks. When rafts, brims, or support structures are attached to the base plate, either metallic or polymer, time required for part removal will increase.

### SUMMARY OF THE INVENTION

The present invention is directed to improved systems and methods for additive manufacturing. According to an embodiment of the present invention, a method for fabricating an object by adding multiple types of materials incrementally point-by-point and layer-by-layer by a three-dimensional (3D) printer includes: calibrating feedstock feeders; calibrating a bonding wedge level and a raft-base plate level; positioning a multi-functional ensemble head (MEH) at a start position with respect to a raft-base plate coupled to a reusable base platen; applying ultrasonic energy in a range of about 20 k to about 200 k Hz to the start position to print a first point on the raft-base plate; applying a weak normal force in a range of about 0.001 N to 10 N to bonding wedges without causing excessive compression on a feedstock material; controlling a change of the normal force and frequency during bonding; printing a first layer on the raft-base plate by printing point-by-point on the first point; adjusting a level and a frequency of the ultrasonic energy based on a type and a property of the feedstock material for multiple, dissimilar material printing; moving the MEH to a next position after printing the first layer; applying ultrasonic energy to the next position to print a next point bonded with the first layer; printing a second layer by printing point-by-point on the next point; repeating moving the MEH to a next position and applying ultrasonic energy to the next position to print point-by-point and layer-by-layer until all layers are printed on the raft-base plate; performing automatic part removal with milling and leaving boundary bridges from the rift-base plate; and performing post-processing, comprising heat treatment up to 1100° C. and deburring/surface-finishing, on the printed object when printing on a last point of a last layer is completed, wherein each of the feedstock feeders contains a different type of feedstock material.

According to another embodiment of the present invention, a system for scalable multiple-material additive manufacturing (SMAM) includes: an on-demand multiple material manufacturing (M3) unit configured to additively print a designed object, the M3 unit comprising a multi-functional ensemble head (MEH) configured for multiple material printing, in-line metrology, in-line error corrective milling, and in-line quality inspection; a process control unit (PCU) configured to autonomously control all functions of the system with remote operation interfaces; an expandable post-processing unit configured to perform heat treatment and polishing/deburring, following the printing; an environmental control unit including an oxygen removal system and particulate filters for additive manufacturing and post-processing; a protective housing providing structural stability and vibration isolation with power and electrical interfaces; a printing head assembly comprising a plurality of printing heads with a multiple feeding mechanism; a laser scanning metrology to monitor dimension discrepancy within a tolerance; and an in-line nondestructive evaluation (NDE) inspection based on ultrasonic or eddy-current probes, configured to find interfacial defects during the printing.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention.

FIG. 1 shows a Scalable Multiple-Material Additive Manufacturing (SMAM) system architecture according to an embodiment of the present invention.

FIG. 2 shows an exemplary embodiment of a Multiple Material Manufacturing (M3) unit according to an embodiment of the present invention.

FIG. 3 shows an internal view of the M3 unit according to an embodiment of the present invention.

FIG. 4 shows a front view of a multi-functional ensemble head (MEH) according to an embodiment of the present invention.

FIG. 5 shows a rear view of the MEH according to an embodiment of the present invention.

FIG. 6 illustrates a bonding wedge connected to the sonotrode with an ultrasonic transducers stack according to an embodiment of the present invention.

FIG. 7 is an example of a precision feedstock mechanism according to an embodiment of the present invention.

FIG. 8 is an overall structure of an M3 unit according to an embodiment of the present invention.

FIG. 9 illustrates a process of SMAM according to an embodiment of the present invention.

FIG. 10 shows configurations of bonding wedges and MEH printing components including wedge types according to an embodiment of the present invention.

FIG. 11 shows exemplary bonding parameters dictating bonding qualities according to an embodiment of the present invention.

FIG. 12 illustrates a cutter operation according to an embodiment of the present invention.

FIG. 13 shows a part removal process according to an embodiment of the present invention.

FIG. 14 illustrates a dual-effective surface of flawless bonding according to an embodiment of the present invention.

FIG. 15 shows an MEH sonotrode with two separate wedges, dual wedges, according to an embodiment of the present invention.

FIG. 16 shows an example of a rotating MEH with dual wedges according to an embodiment of the present invention.

FIG. 17 shows a finite element analysis (FEA) optimization process according to an embodiment of the present invention.

FIG. 18 shows an exemplary dual vibration sonotrode according to an embodiment of the present invention.

### DETAILED DESCRIPTION OF EMBODIMENTS

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the present disclosure. Hereinafter, the present invention will be described with respect to the embodiment(s) illustrated in the annexed drawings.

For the sake of brevity, conventional techniques for additive manufacturing, wire bonding, 3-D printing, and/or the like may not be described in detail herein. Furthermore, the connecting lines shown in various figures contained herein are intended to represent exemplary functional relationships and/or physical or communicative couplings between various elements. It should be noted that many alternative or additional functional relationships may be present in a practical additive manufacturing system and related methods of use.

According to an embodiment of the present invention, Scalable Multiple-Material Additive Manufacturing (SMAM) is directed to a system and a method for fabricating a complex object by adding multiple, dissimilar materials incrementally point-by-point and then layer-by-layers by means of focused ultrasonic energy to contact surfaces with a control for flawless structural, morphological, and microstructural bonding on a single AM platform. The SMAM is suitable for various aerospace-grade metallic parts (alloys of aluminum, titanium, nickel, and other metallic), as well as bonding dissimilar materials (e.g., metals to polymers, metals to glass epoxy, FR4, glass, and flexible ceramics).

The SMAM process can print any material object with very low energy (less than 5 W for 100 micron segment and less than 500 W for mm segment) by adjusting ultrasonic parameters such as power, frequency, application-time/holding-time, input signal profile, depending on the feedstock material types and properties. This is possible because the inventive method maintains thermally effective ultrasonic bonding process with optimized energy application tools and methods.

The SMAM hybrid process creates perfect, void-free, atomic-level bonding between interfacial zones. Unlike resistance welding, electron beam melting and laser melting/sintering known in the art, the SMAM process does not raise the temperature of feedstock material to its melting point. This prevents thermal stress, undesirable compounds, phases, and metallurgical defects that commonly exist in all known fusion/melting approaches.

The SMAM applies well-defined ultrasonic energy to a minuscule segment (or point) of material via a specific contact surface of the inventive bonding wedge such that the minuscule segment strongly bonds on a dissimilar material at subsurface levels through plastic deformation and an atomic diffusion process without melting. A user sets a size of the segment in terms of the contact surface and a feedstock feeder control. The segment is continuously provided to the contact surface of the bonding wedge unless cutting feedstock is required to move or stop.

Shear strain caused by ultrasonic energy, in turn, generates elasto-plastic deformation and microscopic bonding. Thin, layered material flows plastically (plastic deformation) in a narrow interfacial zone of about a few microns in depth and diffusion. Layers of atoms move across the bond interface and form “adhesive” bonds due to van der Waals forces under intimate surface contact. It is noted that the bonds are formed only in an interfacial area underneath the bonding wedges.

According to an embodiment of the present invention, a specific normal force, for example in the range of 0.001 N to 10 N, is applied to the bonding wedge for ultrasonic energy transfer to a feedstock segment in order to make the bonding process near interfacial surfaces and sub-surfaces without causing excessive compression on the feedstock segment. The range of normal force is always monitored and controlled to maintain a preset value or range during printing process.

According to an embodiment of the present invention, a systematic end-to-end AM process for multiple materials includes: a multiple-material AM platform, plural multi-functional printing heads with multiple feeding mechanism including multiple-way manifolds, remote operation interfaces, an in-line laser scanning metrology to monitor dimension discrepancy within a tolerance, an in-line ultrasonic nondestructive evaluation (NDE) inspection to find any interfacial defects during printing, and a post-processing unit as heat treatment and polishing/deburring. According to an embodiment of the present invention, the process is performed using a dual-effective wedge to assure flawless bonding and duplex wedges to solve common AM overhang issues.

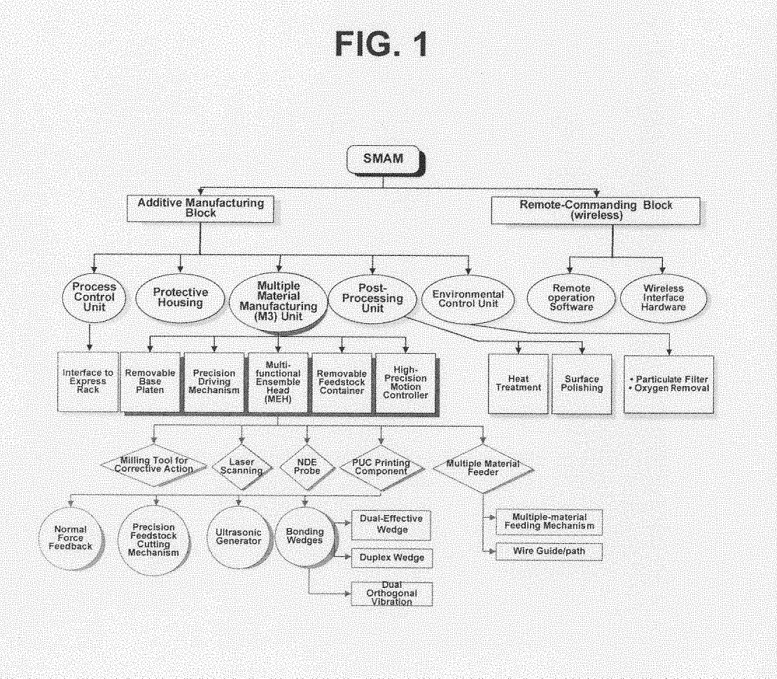

FIG. 1 shows a SMAM system architecture. The SMAM system is divided into two blocks: an Additive Manufacturing block and a Remote-Commanding block that commands/monitors the additive manufacturing block wirelessly or via wired connection.

The Additive Manufacturing block includes three main units and two auxiliary components. Referring to FIG. 1, the on-demand multiple material manufacturing (M3) unit additively prints a designed object with an automated part removal, in-line metrology verification, and in-line ultrasonic and eddy-current nondestructive evaluation (NDE) as quality assurance (QA) during a building process; the post-processing unit, which is expandable, includes selective separate modules, such as heat treatment (up to 1100° C.) and deburring/surface-finishing; the process control unit (PCU) autonomously controls all functions of the SMAM with a communication interface that allows for remote operation, and the interface is installed adjacent to the M3 unit and communicates with the Remote-Commanding block wirelessly or via wired connection; the environmental control unit includes an oxygen removal system and particulate filters for AM and post-processing; the protective housing provides structural stability and vibration isolation with power and electrical interfaces; and the Remote-Commanding block includes interface hardware and software to monitor and control the M3 block.

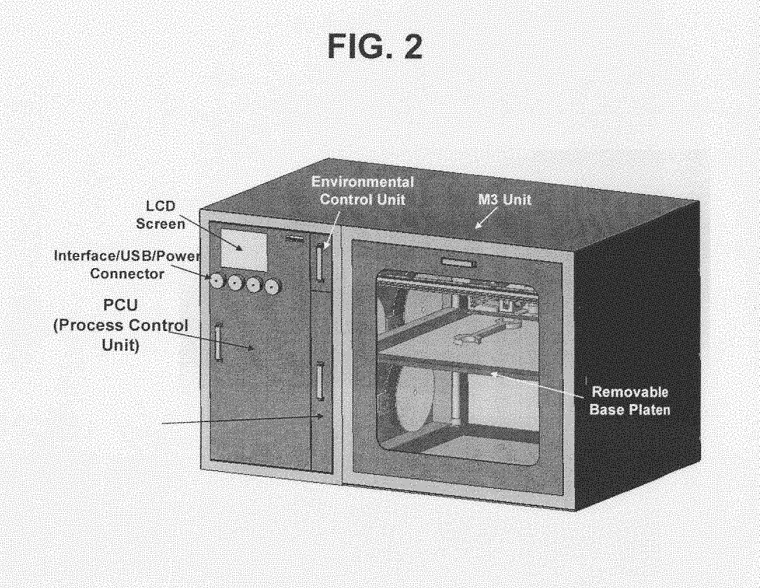

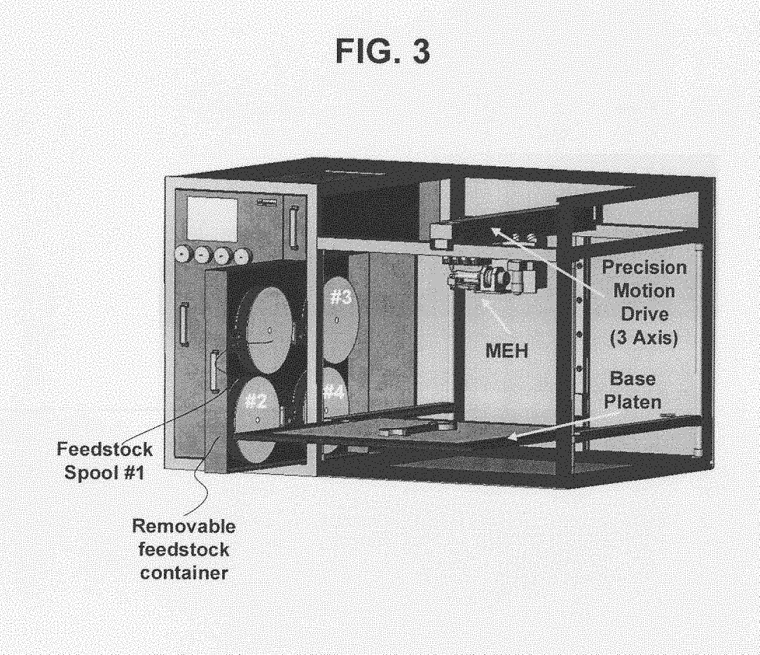

FIG. 2 shows the M3 unit according to an embodiment of the present invention. FIG. 3 shows an internal view of the M3 unit according to an embodiment of the present invention. The removable feedstock container located next to the M3 unit includes multiple feedstock spools for easy replenishment with a sliding and open/close mechanism.

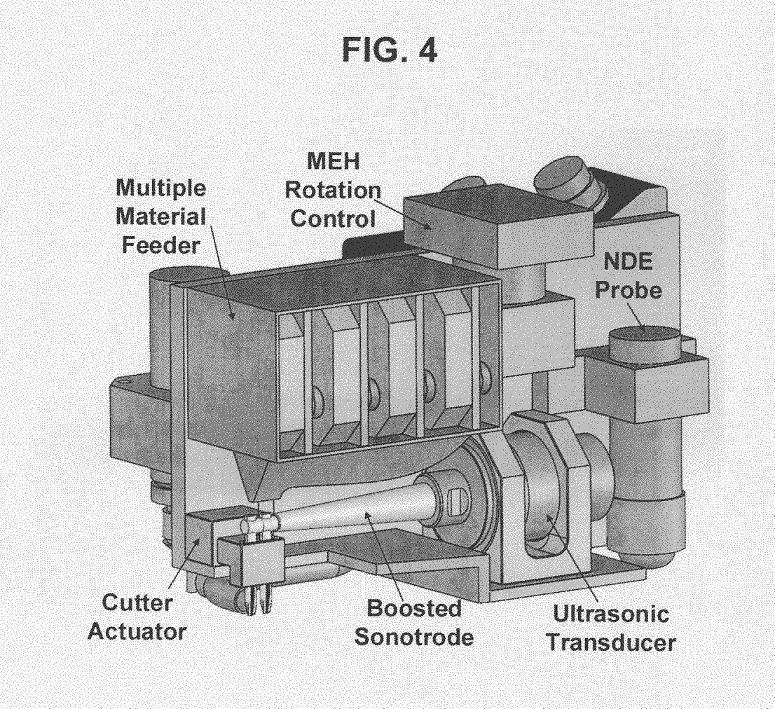

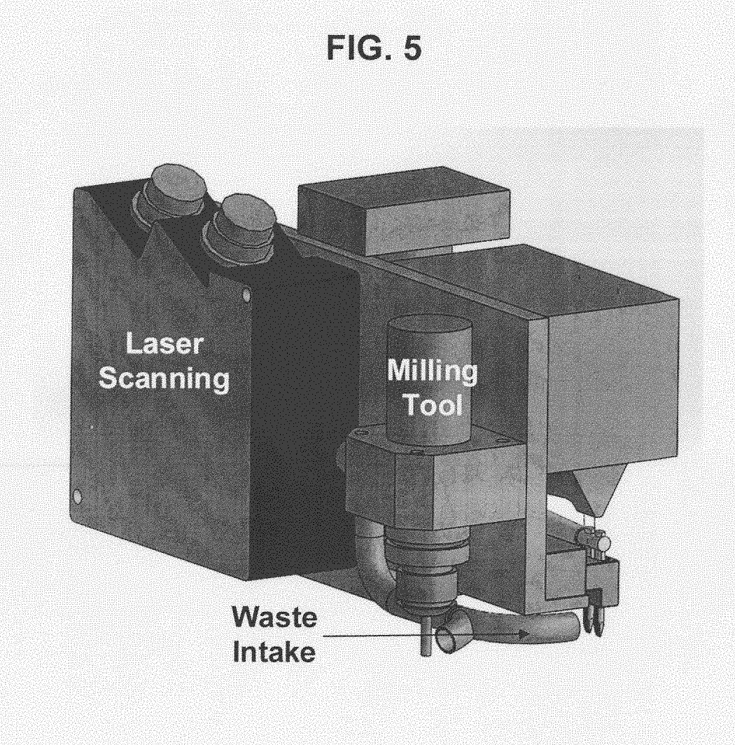

The M3 unit is the main manufacturing unit with a remote/autonomous process control, an in-line build quality check including metrology (μm accuracy), NDE defect inspection, and an in-line corrective action. These multiple functions are embodied by using an integrated printing head with a multiple material feeder in a single head unit, so called multi-functional ensemble head (MEH), as exemplified in FIG. 4 and FIG. 5. Plural MEHs may be embodied as a different configuration.

A MEH comprises an ultrasonic bonding unit for high-precision, multiple-material, and multifunction printing; a laser scanning for in-line metrology to verify dimension within a tolerance range; an in-line NDE inspection device for detecting bonding flaws including an eddy-current probe for metallic materials an ultrasonic NDE probe for all types of material; a milling tool for corrective milling and automatic part removal. According to an embodiment of the present invention, multiple MEHs may be used in the SMAM.

The physical principle of the SMAM process is a combination of atomic diffusion and plastic deformation with an effective break-up and dispersion of surface oxides (impurities) using concentrated delivery of ultrasonic energy (resulting in shear stresses). This physical principle behind the process has already been proven and used in many industries for many years.

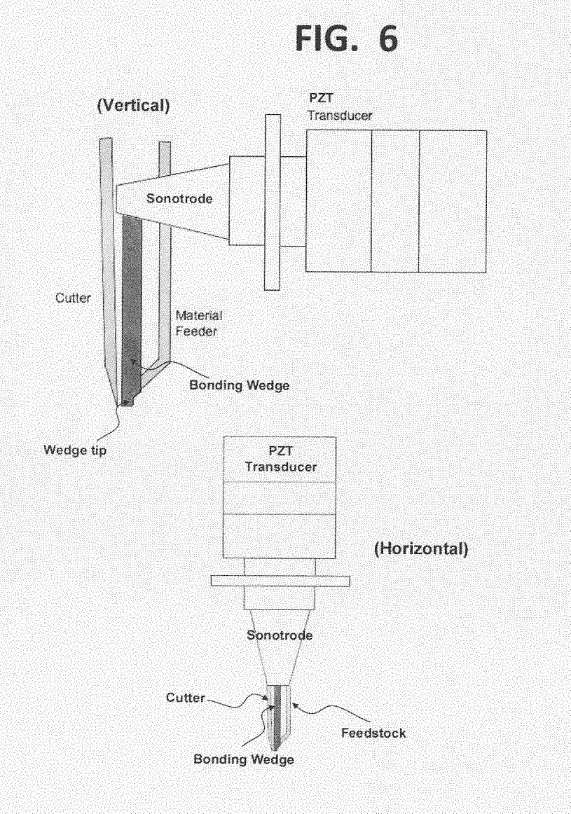

The SMAM uses ultrasonic energy, usually in the range of 20 kHz-200 kHz, amplified through a sonotrode. The energy is focused on a single, end point the bonding wedge (or bonding wedge tip). FIG. 6 illustrates a bonding wedge connected vertically or horizontally to the sonotrode with an ultrasonic transducers stack (made of PZT transducers).

Acoustic plastic deformation occurs in the subsurface zone of a few to 10s μm between interfaces without melting, and results in perfect, void-free, atomic-level bonding between the interfaces. The SMAM feedstock is a thin wire, for example, 12 μm-10 mm in diameter, depending on material or target resolution. For fast printing of a large structure, a thicker wire with a diameter in the range of mm to cm is used with a higher ultrasonic power and normal force. A cross section of the wire may be rectangle, circle, triangle, hexagon, or any other geometric shapes.

A ‘point’ is defined as a segment of material bonded in a single ultrasonic energy application in the SMAM process and preset flexibly by users. For example, a segment of a thin wire, for example, 0.5 mm in length and 300 μm in diameter, is accurately pushed to the wedge tip to be printed as a single point. Different, multiple wires may be dispensed to the bonding wedge tip via a multiple-way manifold from a set of plural spools.

The SMAM process enables any material objects to be printed with very low energy, for example a few watts up to 100 W, depending on the diameter and the material. The SMAM process can print any material object with very low energy, for example, less than 5 W for 100 micron thick segment fed, about 50-about 500 W for a mm thick segment depending on the feedstock material. For example, the SMAM usually consumes about 2 W for 18 μm diameter-gold wire for an ultrasound application time of 35 ms because the SMAM process is not a melting/sintering process. No material melting is caused, and thus, no thermal stress/defects would occur.

Further, the SMAM process inherently addresses the microgravity requirement of AM in space because: the feedstock is a wire in solid form; a normal compression force of for example, 0.1 to a few Newton (N) is always applied to a wire segment fed through the bonding wedge tip while ultrasonic energy is applied; and the SMAM wire feeder mechanism has a closed guiding tube for smooth feeding to the bonding wedge tip. Therefore, the feedstock segment is precisely fed through the guiding tube with forward, backward, and holding (clamping) motions, using the feeder mechanism. Moreover, the bonding process is a solid state bonding without any melting, and thus, is suitable for a microgravity operation in space AM applications.

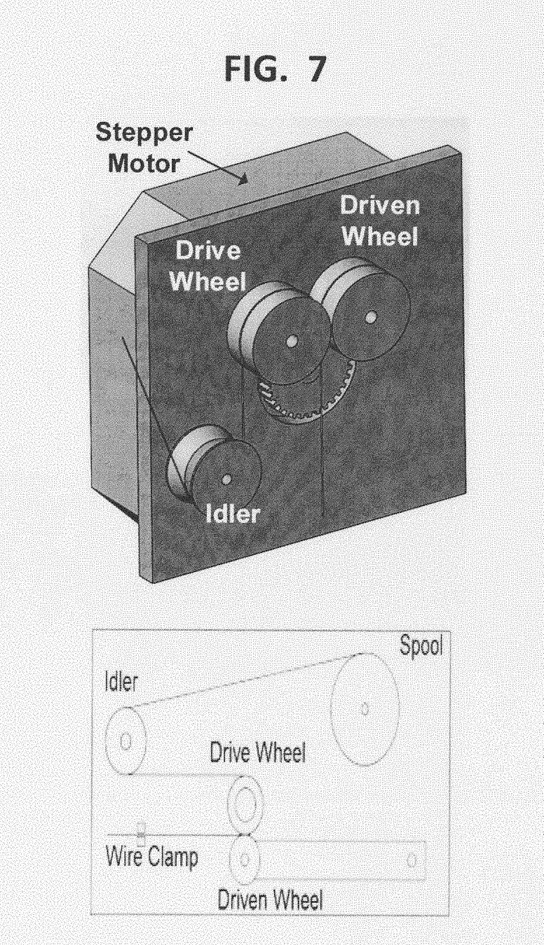

The feedstock is fed to the bonding wedge by a precision feedstock mechanism maintaining tension, advance, calibration, sensing a status of feedstock and calculating remaining amounts. Multiple feedstock spools are stored in the removable feedstock container. As seen in FIG. 7, a multiple material feeding/guiding mechanism is integrated with the MEH and is capable of dispensing multiple different wire feedstock (when all feedstock spools contain different materials). The multiple material feeding/guiding mechanism also can dispense the same material to print a larger object without feedstock resupply when all feedstock spools contain an identical material.

The multiple material feeder equipped with the multiple material feeding/guiding mechanism is capable of handling wires as fine as 10 μm in diameter with high precision and repeatability by using a set of self-adjusting drive wheel. A wire fed to the wedge is always protected by the guide tube. A clamp near the bonding wedges is part of the feeding mechanism and holds the wire segment to maintain feeding accuracy and assist motion.

The SMAM feeding mechanism feeds the wire at a correct force to avoid damaging it by sending feedstock tension measured at spools and in self-adjusting drive wheels. The feeding/guiding mechanism also provides an adequate force by a wheel spring or a frictional surface to grip a wire with a small diameter for continuous operation. Since the axial loading condition and poor strength of the microwire may cause buckling, the feed rolls is placed as close to the wedges as possible.

The feeding mechanism control uses the following parameters: calibration, a number of rollers, angle of inclination, the pinch roller, tension sensing and control, and precision guidance. The feeder has a three-way manifold that separately dispenses three different materials guided to the main bonding wedge.

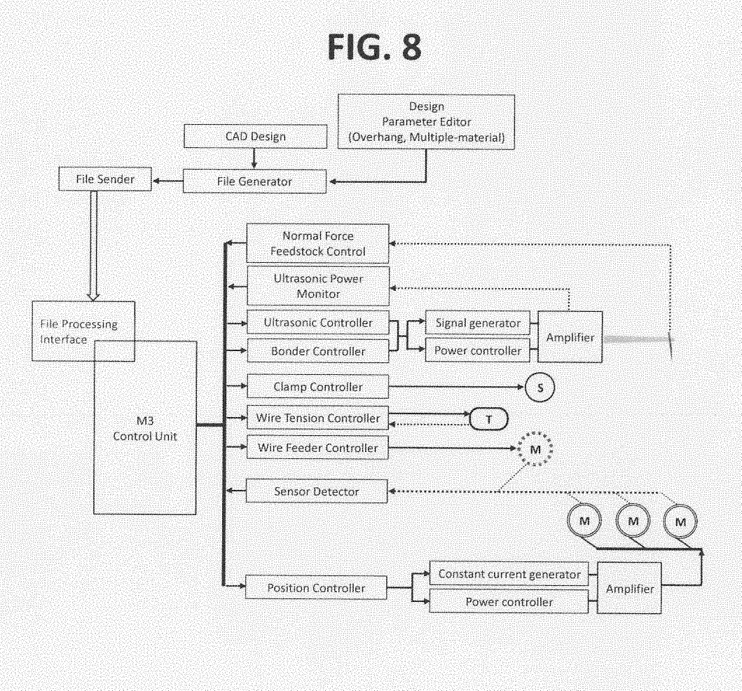

An overall control structure is shown in FIG. 8. Normal force feedback control is applied to control a magnitude of normal force in order to achieve lossless ultrasonic energy transfer and to compensate a resonance frequency shift when a bonding condition changes. The normal force feedback control governs a firm, clean bonding with a very small normal force. The SMAM process according to an embodiment of the present invention does not require a force that is higher than 1 Os of Newton for bonding, which is very unique. For a thin wire of 100 micron, less than 1 N of force is enough with the normal force feedback.

The intelligent corrective-action is performed to correct dimensional discrepancies by using a milling tool on the MEH. If a dimension discrepancy or a bonding flaw is identified from the in-line metrology device or the NDE inspection, the MEH intervenes to correct the inconsistencies using the milling tool module. The in-line metrology and NDE inspection are performed at a preset interval or after a preset number of layers is printed. If a discrepancy is found then the MEH corrective action is activated. A normal force change and a resonance frequency shift during bonding may indicate a possible flaw and/or imperfection in bonding. The normal force and the resonance frequency of the MEH are monitored in terms of force and voltage respectively. An unexpected change exceeding a preset tolerance activates the in-line metrology and NDE inspection. If a measurement requires additional materials for correction, the MEH is activated to print an additional portion as calculated and then repeat the correction process.

As in-line dimensional check, the MEH is integrated with a laser scanner to measure a part being printed with accuracy at a μm level at a periodic interval preset by the user. A laser scanner based on line triangulation is integrated into the MEH. Using the position of the light point, the location of the measured object is calculated. The measurement data is stored and used to check whether or not the dimensional data on the layer matches the design data. The control software for data acquisition and analysis is integrated with the C/C++ library for execution on a general computational platform. This function enables in-line intelligent corrective-action during build to correct dimensional discrepancies by using a milling tool on the printing head assembly.

As in-line ultrasonic nondestructive test for QA, the SMAM performs tests periodically to detect flaws (voids, cracks, etc. at the sub-micron level) during the printing process by using a high frequency, short-pulse, ultrasonic NDE method, similar to a scanning acoustic microscope. A high-frequency (MHz) ultrasonic probe is installed on the MEH so that the probe can freely scan built layers. Eddy-current probes are also used for metal inspection. The M3 software is used for scan control/analysis and hardware is used to drive the probe (pulser/receiver) with data communication to the SMAM.

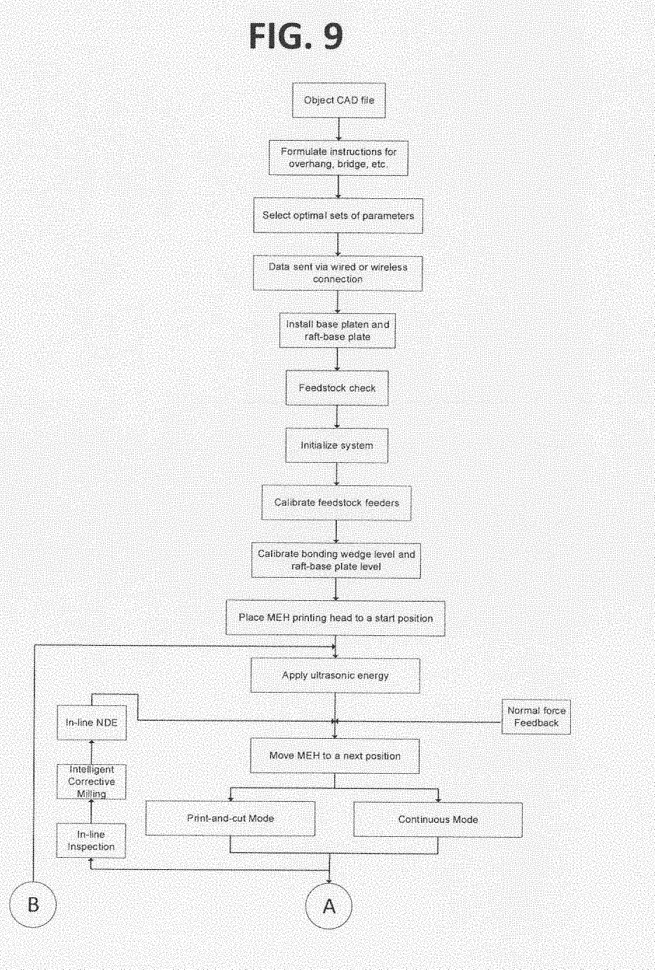

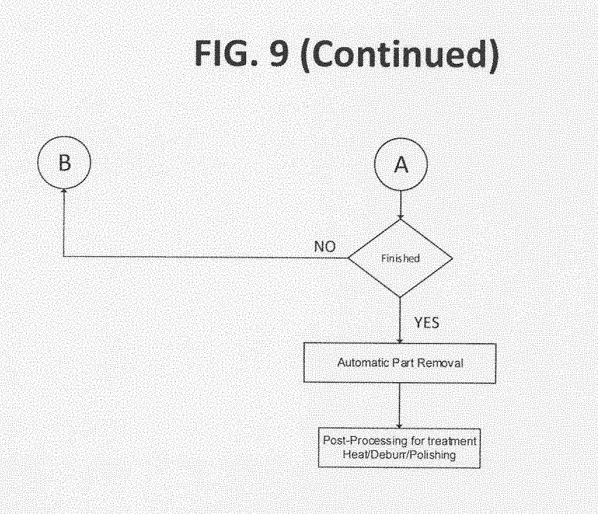

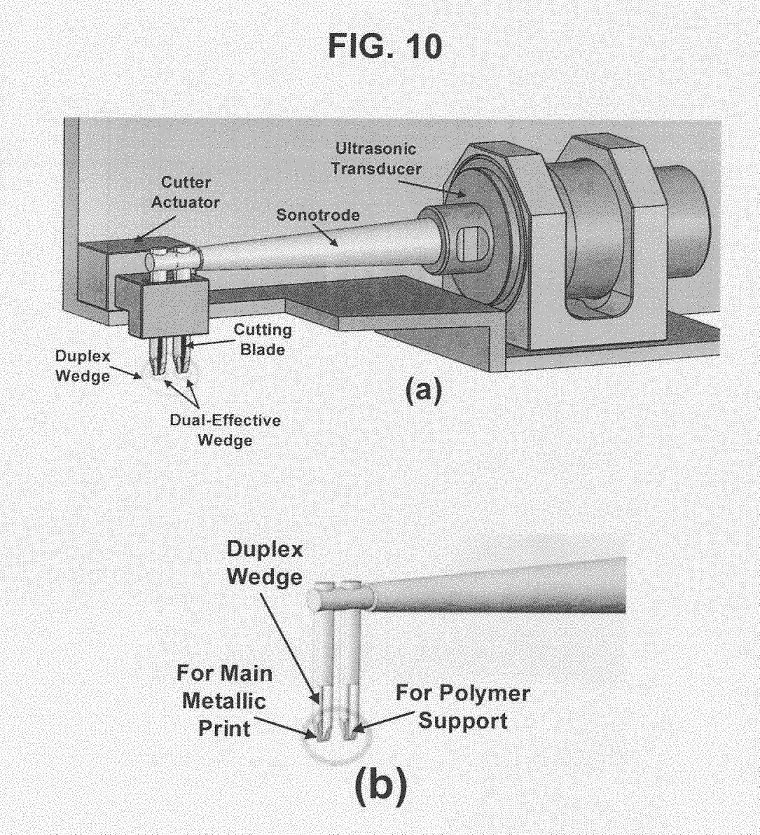

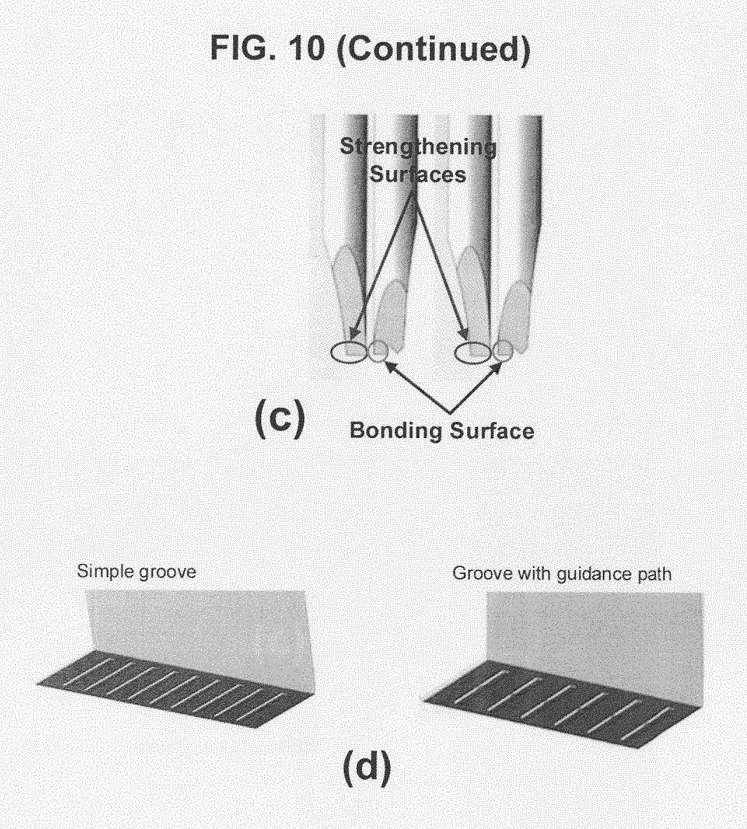

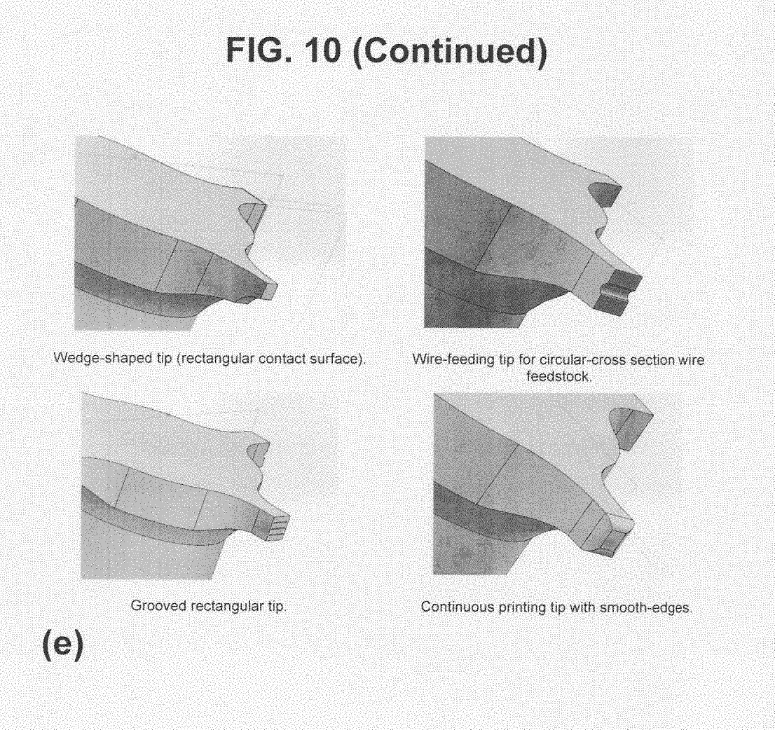

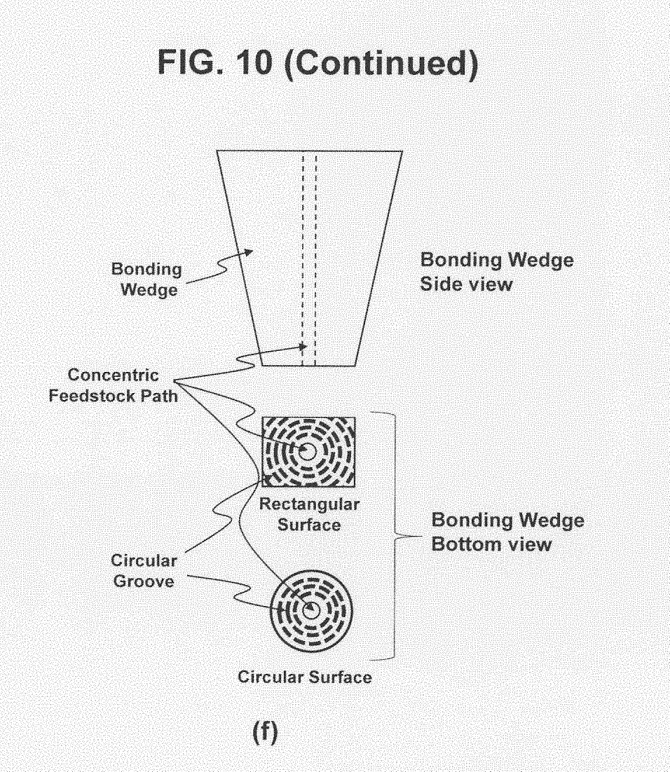

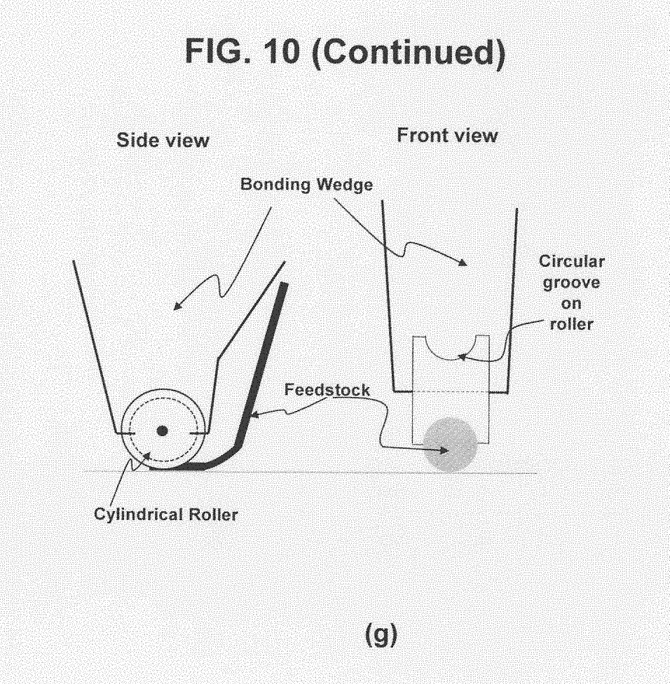

FIG. 9 illustrates a process of the SMAM. A target object drawn with a CAD is transferred to the M3 unit via a wireless module for remote operation or via wired interface. FIG. 10(a) shows MEH printing components including an ultrasonic transducer stack, a boosted sonotrode, and two sets of bonding wedges (duplex wedges shown in FIG. 10(b)) at the end of the sonotrode for synchronized multiple-material AM on a single AM platform. Each set of the bonding wedge is used for different material printing on a single MEH without exchanging the MEH. Each set of bonding wedge has its own cutting blade to cut a wire segment when necessary.

Each set of wedge has two bonding surfaces (called dual-effective surfaces as shown in FIG. 10(c)), one for initial bonding and the other for secondary strengthening. Since the wedge and sonotrode are subject to high stress, they need high strength and good acoustic properties (transmit sound energy efficiently). Titanium alloy sonotrodes are the strongest possible (Grades 6-4 and 7-4) and are preferably used for the SMAM.

For the bonding wedge, titanium, tungsten carbide or ceramic is used. The bonding wedges must not be easily contaminated with a feedstock material and worn out. A cross groove on the bottom surface of the wedge end tip is required to achieve a good bond. The extra mechanical ‘gripping’ action of the cross groove provides a higher ultrasonic coupling to the bonding surface as seen in FIG. 10(d).

The bonding wedge tip has numerous variants as exemplified in FIG. 10(e). Each tip has a different function and shape such as a rectangular contact surface tip, a wire-feeding groove for typical wire feedstock, a grooved rectangular tip preventing potential surface slips, and a continuous printing tip with smooth-edges useful for continuous printing without ripping or denting feedstocks. The groove shape has many variants such as linear, circular, zigzag, chevron, etc.

FIG. 10(f) illustrates that the bonding wedge may be embodied as a circular or rectangular bottom surface with a concentric feedstock path that enables the printing direction more freely changed without wrinkle or kink on a being-fed segment. FIG. 10(g) illustrates a bonding wedge according to another embodiment of the present invention, for example, a roller type bottom surface with a circular wire guiding groove. The roller has a cylindrical shape and rolls along the fed feedstock segment. The circular guiding groove can be changed to other shapes according to the cross section of feedstock.

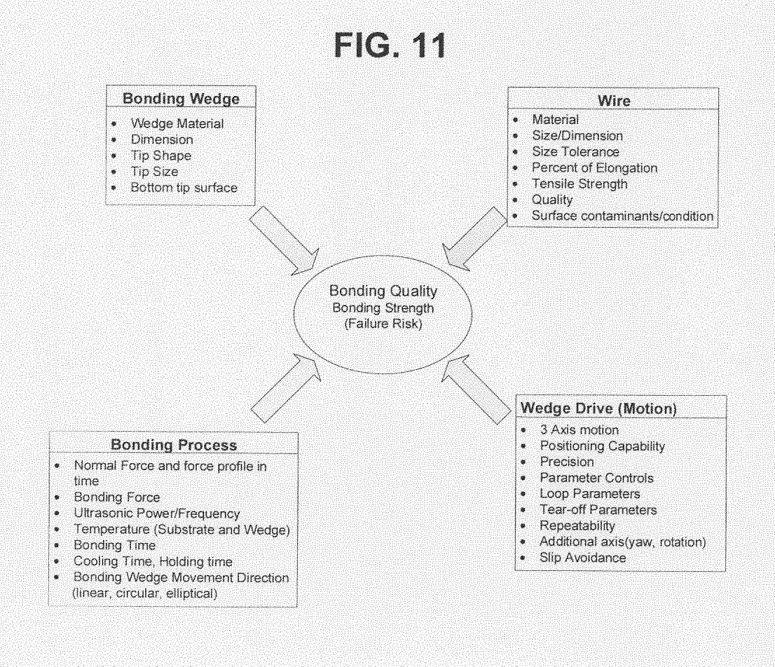

Special instructions for the SMAM's duplex and dual-effective operation are added in CAD sliced files, such as STL, AMF, X3D, Collada, and Obj, to avoid problems caused by voids, overhangs, bridges, and exceeding a 45 degree angle. For example, special instructions include preset process parameters with optimal combination for motion directions, sequences of feedstock supply, MEH rotation, adjustment of bonding parameters, etc. These instructions are computed and embedded into CAD sliced files. All parameters pertaining to all subsystem, modules, components of the SMAM are not listed herein, and they are not limited to the above-identified parameters. The process parameters are adaptively changed during the AM process on sensor data. FIG. 11 shows exemplary bonding parameters dictating bonding qualities.

A multiple set of plural materials feedstock is prepared or checked to have enough amounts to build the target object before printing begins. Initialization and calibration of hardware are performed along with cleaning. A feedstock multiple material feeder is calibrated to align and place a feedstock segment to the beneath of the bonding wedge surface.

A reusable base platen made of hard material, for example, titanium with thickness of 10 mm, is prepared. The base platen holds a starting surface, i.e., a thin plate named as raft-base plate, on which the first layer is to be printed. The base platen is easily removable from and lockable on the M3 unit. The raft-base plate may be cut away for part removal after the printing is complete. A removable feedstock container, located next to the M3 unit as seen in FIG. 3, holds plural spools for feedstock supply.

Calibration of the bonding wedge is performed automatically with multiple cameras by image processing to ensure that the pointing direction of the bonding wedge tip is always normal to a contact surface, adjusting a posture of the bonding wedge or the overall sonotrode stack containing the bonding wedge, if necessary. The calibration must be combined with the fastened raft-base plate to the base platen because the contact surface is laid on the raft-base plate. The bonding wedge and the base platen may have identification marks for calibration. A calibration camera holder equips two cameras at fixed, pre-calculated locations. A camera is placed along the bonding wedge taking an image frame of a pointing direction of the wedge. Another camera orthogonal to the first camera and parallel to the plane of the base platen to the raft-base plate takes a level of the plate. Based on two images, a misalignment of the bonding wedge on the plane of plate installation is computed. The bonding wedge are aligned to be a normal to the plane of plate installation

The MEH is moved to a first position to be ready for printing. The MEH printing head is lowered with a normal contact force and ultrasonic energy is applied to the point with preset parameters. The energy application time is changed according to material class and may add an additional time for atomic bonding cool-down.

The MEH continues to print point-by-point to complete a layer according to given control instructions and then move on to the layer. When the MEH moves without printing, the cutting operation is performed.

The SMAM provides two printing modes: a print-and-cut mode for moving the MEH to the next position without any printing with cutting; and a continuous-point mode where ultrasonic energy is applied continuously point-wise, but without feedstock cutting. When the MEH needs to move to the next position without printing or to make a sharp turn, which may cause a kink (or wrinkle), the cutting blade is activated to cut wire; the MEH is repositioned to the next point; and then printing is resumed. The cutting blade is designed to be integrated with the dual-effective wedge. This continuous-point mode is effective for quickly producing a linear or slowly-curved portion of a part with seamless surfaces.

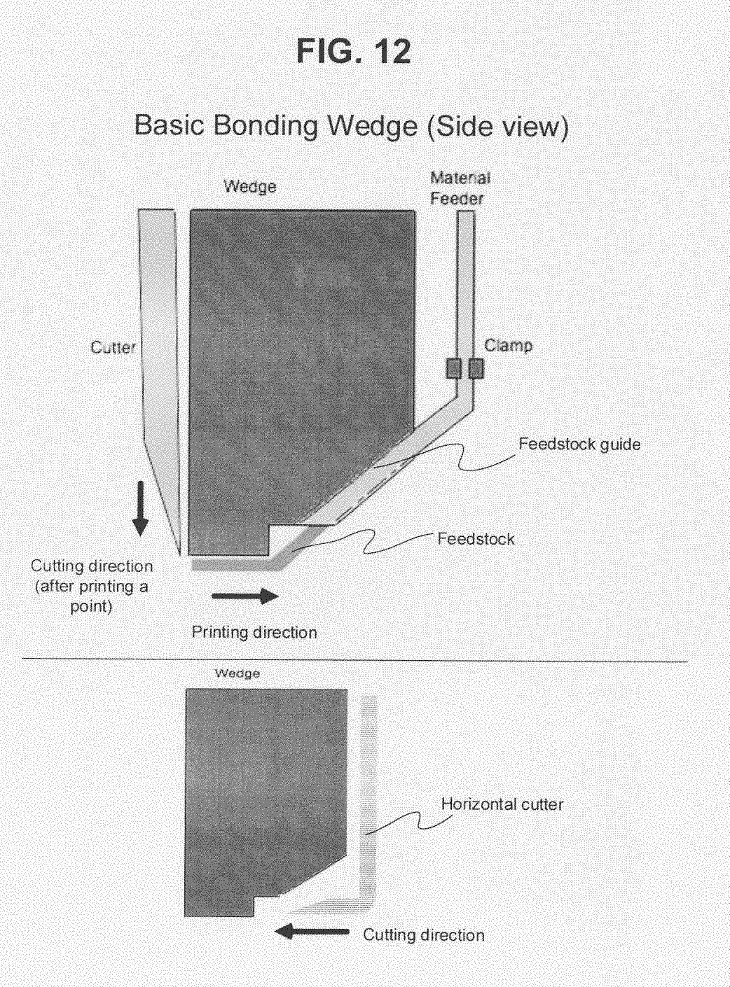

FIG. 12 illustrates a cutting operation performed by the cutter. The cutter can be embodied as vertical cut, horizontal cut, or slant cut. When the cutting operation is performed, a slight MEH motion control is added to maintain an optimal tension before cutting. The cutter blade may have different shapes for different bonding wedge types and dimensions.

The inventive autonomous part removal in the SMAM is a process including: removing the raft-base plate (a media for first layer) from the base platen by unlocking, turning over, and reinserting the raft-base plate for autonomous cutting/milling on the bottom of the printed build (i.e., part removal). The SMAM does not directly print a part on the base platen.

The inventive raft-base plate is securely attached to the base platen so as to provide a firm base without slip during the printing process. The raft-base plate is a thin metallic or polymer plate, for example 0.5 mm˜10 mm thick, depending on material hardness. The first layer of a part is printed on the raft-base plate.

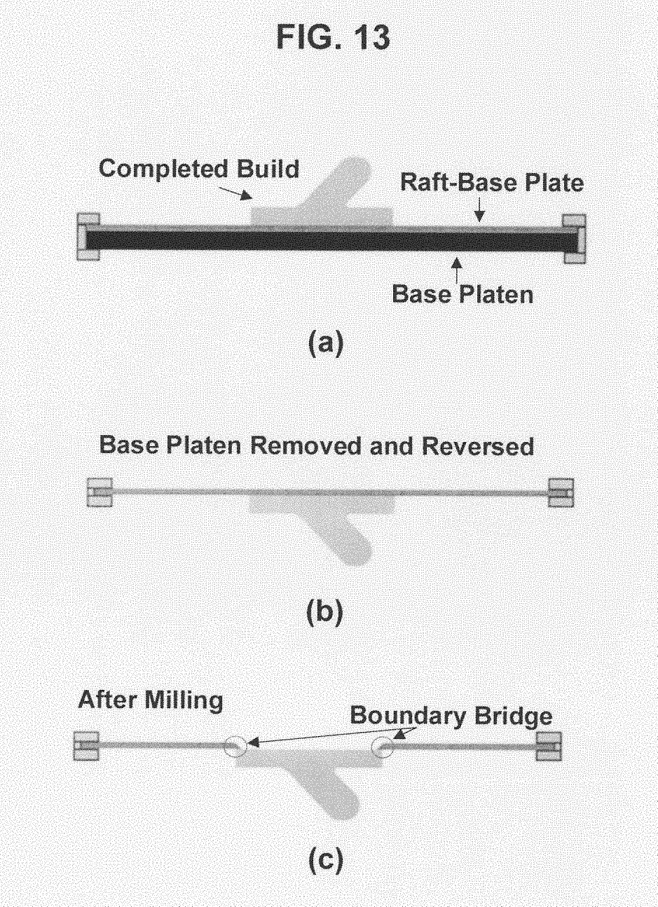

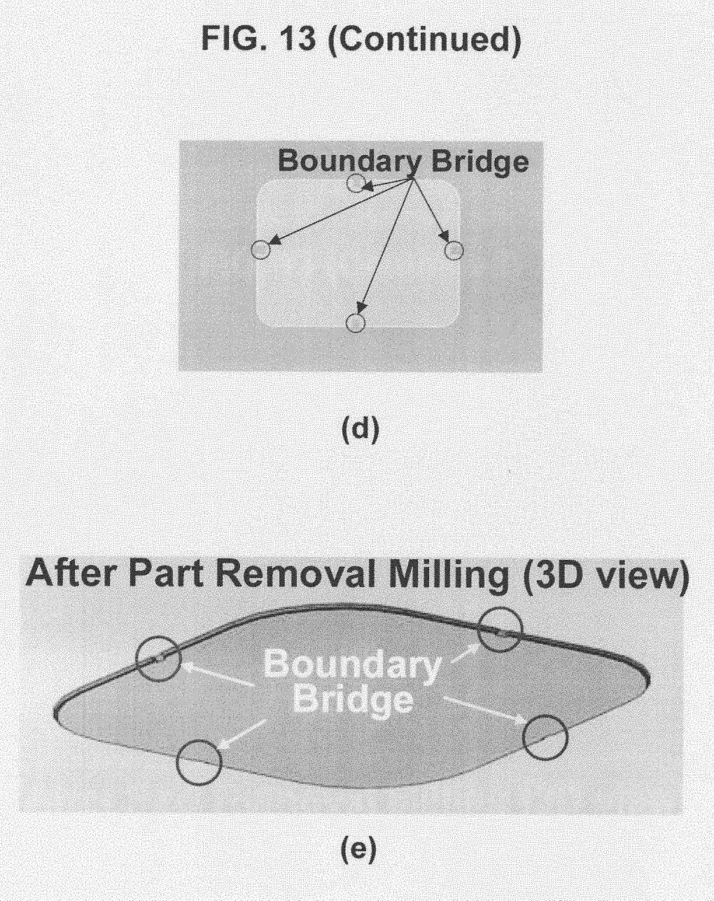

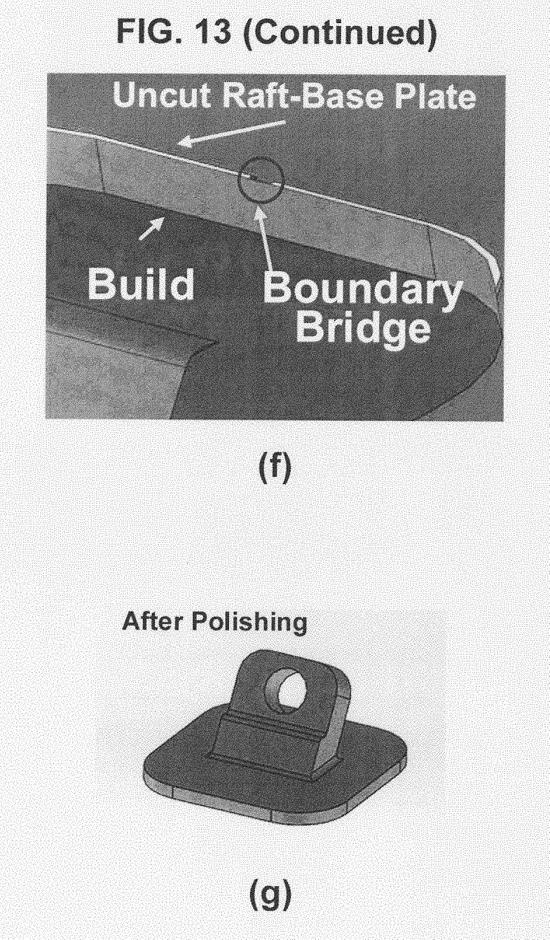

Referring to FIG. 13, when the build is completed (FIG. 13(a)), the raft-base plate with the build attached is detached or unfastened from the base platen, reversed, and re-inserted into the M3 for part removal (FIG. 13(b)). The milling tool on the MEH is activated and begins to remove the raft-base plate portion on the bottom of the build, which is slightly larger than the boundary of the build except boundary bridges defined before part removal (FIGS. 13(c), 13(d), 13(e), and 13(f)). Several boundary points (bridges) are left so that the build is barely attached to the raft-base plate (FIGS. 13(d), 13(e), and 13(f)).

The milling is performed accurately so that additional milling would not be necessary. The bridges are easily cut and polished to remove leftover material, if any. Then, the build (FIG. 13(g)) is transferred to the post-processing unit.

In order to build flawless AM at every point, the bonding wedge has two separate application areas as shown in FIG. 10(c). The dual-effective surface is for flawless interfacial bonding in all directions (top/bottom and lateral sides). Each bonding wedge has two effective and distanced surfaces, i.e., a bonding surface for initial bonding and a strengthening surface for secondary bonding fortification. The bonding surface is a normal ultrasonic energy applicator, and the strengthening surface fortifies an already-bonded segment from the previous step using a secondary energy application, which is about 1.5 times larger than the bonding surface covering neighboring interfaces/zones.

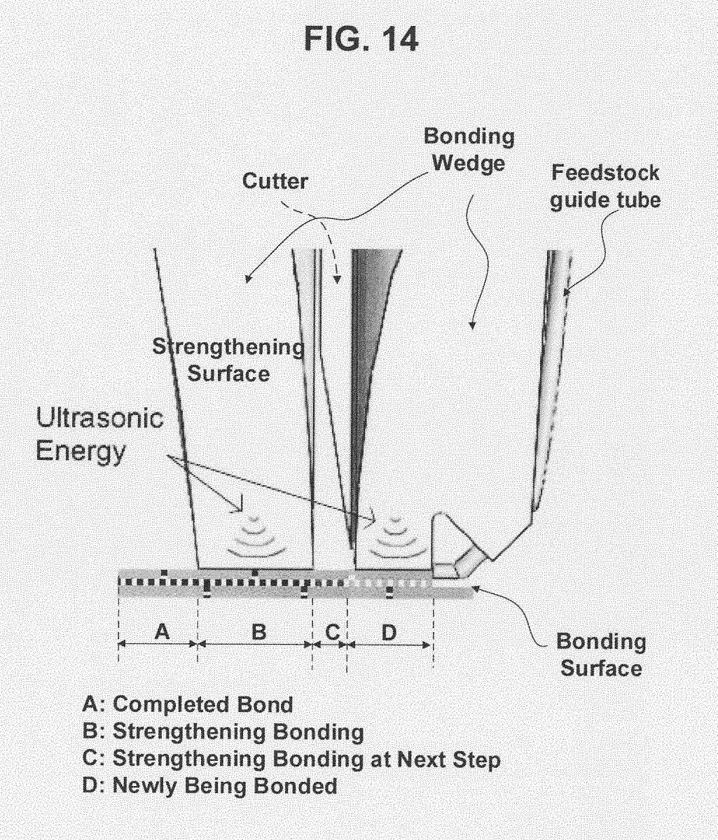

As shown in FIG. 14, while the bonding surface applies ultrasonic energy for a new point (D in FIG. 14) on the right side, the strengthening surface (B in FIG. 14) on the left side, which is positioned a half a segment distance from the bonding surface, applies ultrasonic energy to bonded lateral and horizontal interfaces to assure no void or incomplete bonding surface. In the next printing step, D and C in FIG. 14 are placed under the strengthening surface for bonding fortification. The distance between the bonding surface and the strengthening surface can be adjusted from zero to a preset segment (point) size.

Build complexity, such as overhangs or protrusions, bridges, and exceeding an angle of 45 degree, causes build failures and are very common in all AM. Typically, the overhangs are addressed by using additional support structures. However, removal of such supports after build completion is not easy, and it creates an added, troublesome process in all known AM methods.

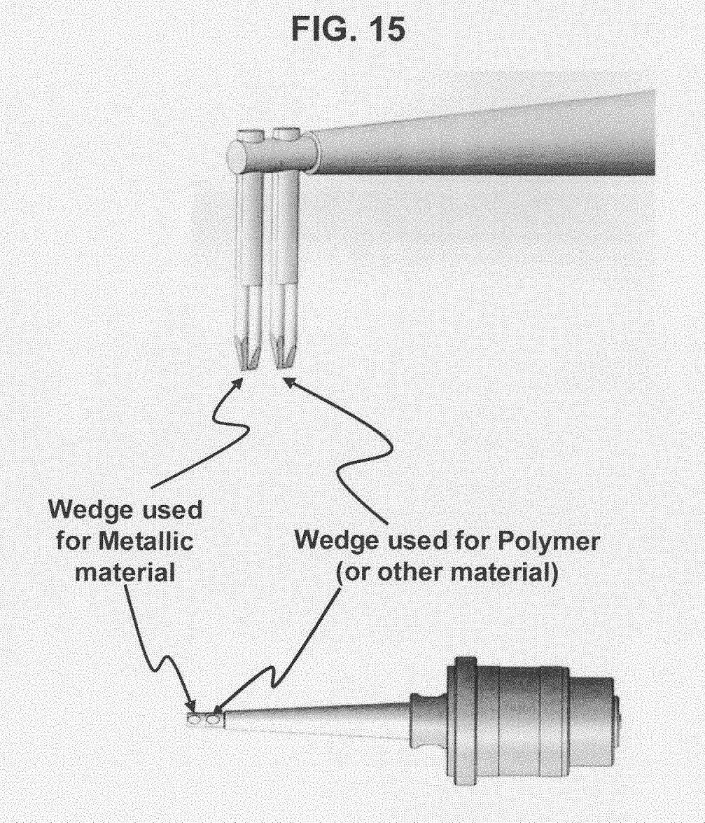

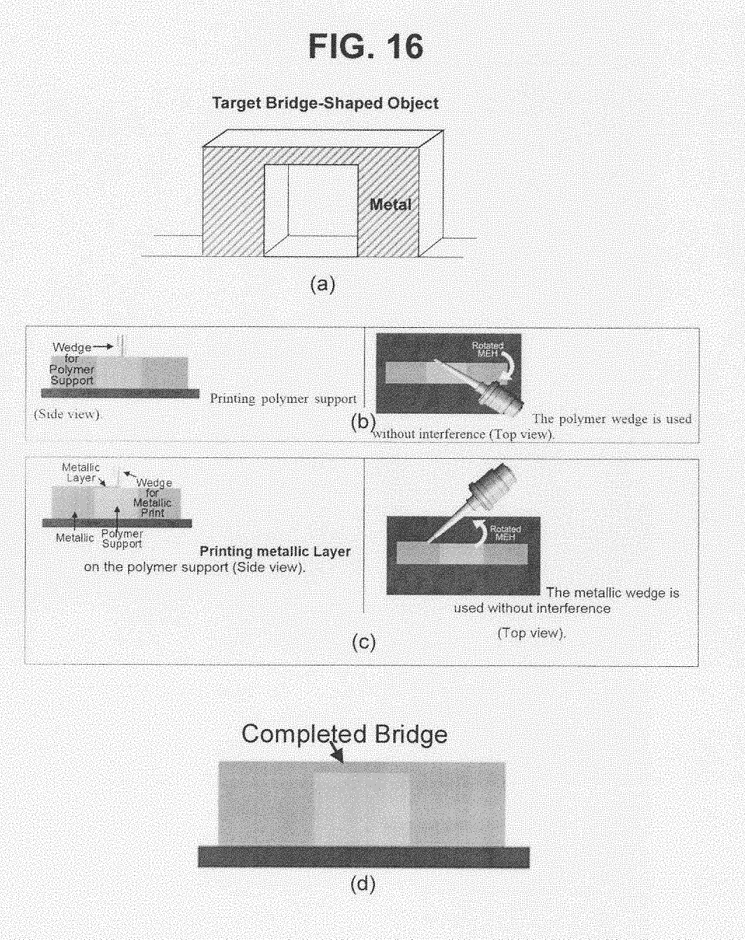

The duplex wedge is to print two different class materials seamlessly by slightly rotating the MEH without changing the MEH printing head. In addition, the SMAM's duplex wedge, exemplified in FIG. 15, solves overhang problems and helps removal of supports/rafts. Two bonding wedges are placed in series to fabricate two different types of materials at the same time without delaying the process with feedstock or tool changes. During printing of an overhang portion (e.g., metallic bridge as shown in FIG. 16(a)), the duplex wedge prints a main part in metal and its support part in polymer. For example, the main (metal) wedge is at the far-end of the sonotrode for metallic printing, and the secondary one is used for the polymer, as shown in FIG. 15, because the power (longitudinal displacement) of ultrasonic energy is stronger at the far-end.

As shown in FIG. 16, the MEH sonotrode has two separate wedges at the end. The first wedge at the far-end is used to print metallic materials in the normal process. The second (polymer) wedge is used to print a support structure in polymer when an overhang occurs, wherein the support structure is identified in advance during the CAD design process. Firm support structures can be made of polymer so that an overhang or bridge is securely printed despite the geometric complexity. Further, polymer is much easier to remove from a metallic surface.

The polymer for a support structure is structurally hard, but with relatively weak bonding to metal such as acrylonitrile butadiene styrene (ABS) and so on, and thus, the polymer support is easily removed after the build is complete. To ensure easy removal, different types of polymers are used for different types of metals.

Moreover, the MEH is configured to rotate to avoid interfering with the path of the wedge or hindering printing when the second wedge is activated, as shown in FIGS. 16(b) and 16(c). FIG. 16(d) shows the completed bridge. Thus, according to the present invention, overhang problems and the removal of supports/rafts are solved.

The duplex wedge function is also very useful in quickly building a part from heterogeneous materials (e.g., metal and polymer, or a PCB with copper patterns) because no feedstock material or printing head changes are required.

The main wedge (at the far-end of the sonotrode) uses a 3-way manifold to connect each independently-controlled microwire feeding mechanism so that three different types of materials (for example, Ti, Al, stainless alloys, etc.) can be fed as desired. The SMAM provides an in-line inspection strategy to enable validation and verification (V&V) and QA capability to a certain degree as integrated into the MEH. Dimensional accuracy describes how closely the M3's output conforms to tolerance within a specified dimensional range. Accuracy in AM is a function of the system's capability to control the motion of the material deposition across the entire build envelope. The SMAM system is dependent on an exact length of the feedstock of a solid form precisely dispensed.

The SMAM has no thermal expansion or contraction. Hence, the SMAM ensures a higher accuracy and much smoother finished surfaces. Moreover, the M3's motion control has an accuracy of a few microns, or even sub-microns.

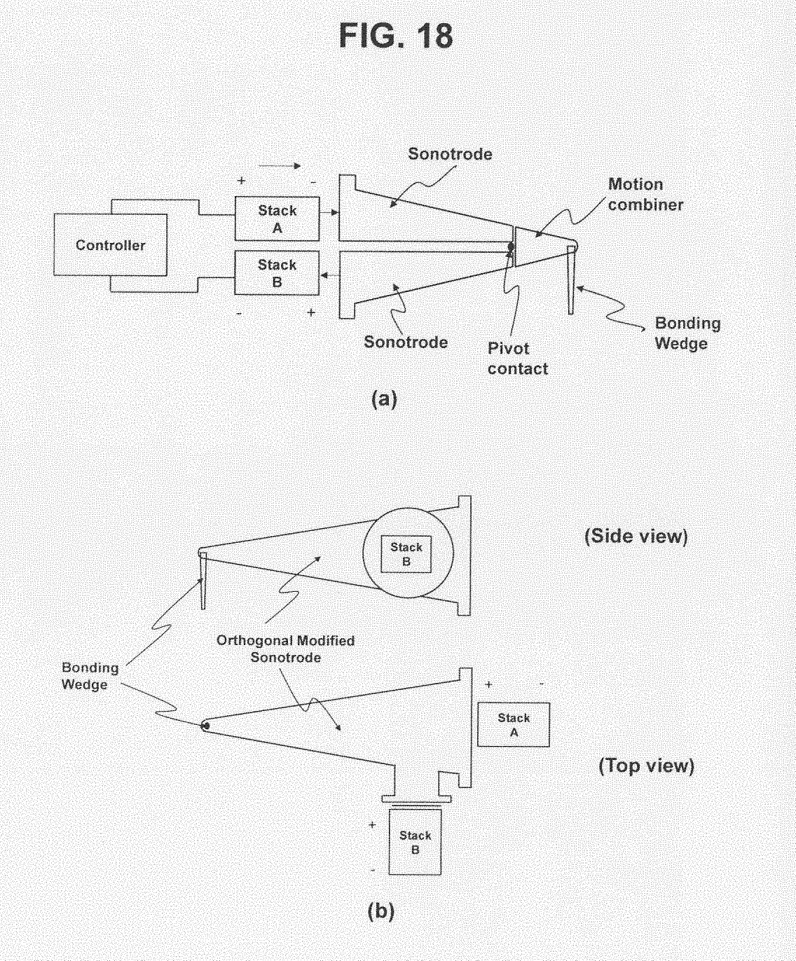

The dual directional vibrations whose motion direction is orthogonal to each other using the dual sonotrode head evenly distribute shear strain on a consolidation interface. Any shapes and types of bonding wedges can be installed in the dual-vibration sonotrode. Resulting motions on the bonding wedge may be linear, circular, elliptical, and so on, depending on a combination of driving frequencies. Referring to FIG. 18, the dual-vibration sonotrode head includes two separate ultrasonic transducers to generate vibration, a booster for each transducer to amplify ultrasonic energy. Two sets of ultrasonic transducers are alternatively controlled by sending electrical signals with opposite polarity. Another embodiment is to place each set of transducers physically in an orthogonal way.

The SMAM may also be used for electronics fabrication AM because the SMAM is capable of bonding dissimilar materials (e.g., building conductive (copper) circuitry patterns on fire-resistant insulating polymer/ceramic materials and then repeating the multiple layering, printing passive electronic components (resistors, capacitors, etc.), and glass epoxy to copper). Various materials, such as glass-fiber resin/epoxy (FR4/G10), flexible ceramics, etc., with a component pick-and-place function, are used to build a complete electronics board, components, and parts.

For example, starting from an FR4 substrate, copper circuitry patterns are printed point-by-point, insulation layers are printed or embedded, and these are repeated to fabricate a multi-layered print circuit board (PCB). The present invention enables to fabricate a via, an electrical connection path between PCB layers. Also, passive electric components (such as resistors, capacitors, etc.) can be printed. A set of packaging components around a silicon chip (die) with all planar and 3D electrical paths can be printed on a PCB.

The SMAM may be used as a method for on-demand repair of electronic components integrated with the SMAM process. This is very useful for electronics fabrication and repair.

According to an embodiment of the present invention, the SMAM can be embodied as a holistic or partial semiconductor packaging method. The SMAM for semiconductor packaging comprises a microsized feedstock for micron-level accuracy, a precision multiple material feedstock feeder, and a motion platform of submicron-level accuracy. The system is specifically modified to take care of sub-μm level accuracy and resolution in all operation parameters. The system additively builds heterogeneous, microsized silicon chip die-packaging components point-by-point and then layer-by-layer around silicon chips (CPU, GPU, ASIC, etc.) using multiple materials on a single additive manufacturing platform. The SMAM provides holistic, ultrafine die-packaging not only for old packaging types (QFP/PGA/BGA), but also for new packaging types (FCBGA/WLCSP, 3DIC, etc.) while ensuring protection against impact, corrosion, heat dissipation, and counterfeiting. The MEH can build contacts, pins or leads, bumps, insulators, filling, etc. with metal, polymer, and ceramics on a single SMAM platform. The SMAM can print a redistribution layer (RDL), i.e., reroute connections on the chip's surface for compact packaging in a wafer level chip scale package (WLCSP) without additional processes.

The SMAM's point-by-point capability enables a variety of packaging elements, such as dielectric pad, bumps, balls, vias, circuit path, filler, interposer, RDLs, contacts, patterns, metal casing, etc., with different materials such as resin, dielectric, copper, gold, silver, alloys, and so on. The SMAM can be integrated with additional potting/molded plastics/liquid filling/UV-curing modules to be a holistic, stream-lined process for complete silicon die-packaging.

The Process Control Unit (PCU) includes hardware such as main CPU boards, network interface, ultrasonic signal generator/interface, linear servo motor/controller, spindle and motor with controller, servomotor/encoder, ultrasonic probe and pulser/receiver, laser scanner controller, air suction with filter, oxygen removal, electric furnace, and magnetic tumbler. The PCU also includes associated software and firmware.

An environmental control unit includes an oxygen removal system and particulate filters for AM and post-processing. Thus, the M3 unit does not need the oxygen removal system with a feedstock of greater than 20 μm in diameter. The oxygen removal system is operated only when the wire diameter is less than 25 μm to eliminate accidental inhalation. There is no explosion risk. A particulate filter system is installed at the MEH to suction particulates or fragments generated when milling for part removal and as corrective action proceeds. The environmental control unit also contains oxygen removal/trap system, which is capable of reducing oxygen down to a few parts per billion (ppb).

A particulate filter system is capable of filtering ultrafine particles (UFPs) and volatile organic compounds (VOCs). A three stage particulate-filter system removes the VOC and ultrafine particles. In the first stage, the air flows through a coarse pre-filter layer, and an activated carbon filter. Then, a High efficiency particulate air (HEPA) U15 (99.9995% efficient) filter removes the ultrafine particles (0.3 μm). The filtered air is recirculated back into the enclosure, and the filtering process is continued until the 3D printing ends.

The SMAM does not generate chemical fumes or metallic particles because the SMAM process is a cold solid state process. The SMAM process is clean and simple, using less real estate than SOTA powder-using AM, and does not require a powder container, an inert gas chamber supplied with hermitical operation, nor a powder removal/cleaning station.

Post-processing is important, but difficult due to different requirements for target builds, functions, and materials. For example, heat treatment alone varies from carbonizing, tempering, hardening, annealing, stress relieving, etc. A surface finishing process is also essential to ensure a smooth surface, such as polishing, honing, buffing, barrel tumbling, lapping, electroplating, abrasive grinding, inorganic coating, anodizing, etc. The SMAM integrates an essential post-process such as a furnace without vacuum/gas as a heat treatment device and a magnetic/non-magnetic tumbler for polishing/deburring.

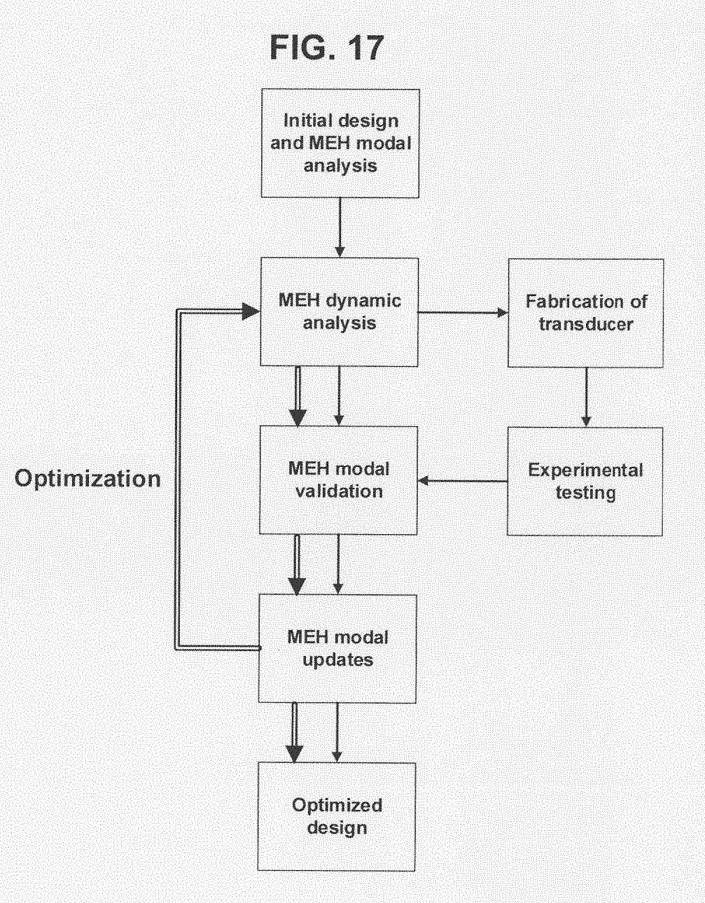

To maximize the SMAM performance, the MEH sonotrode combined with the bonding wedges is tuned to all optimal parameters before fabrication because the sonotrode is a machined object. FIG. 17 shows a finite element analysis (FEA) optimization process that searches for the maximum energy transfer mode for a given sonotrode geometry. The FEA model is based on an eigen-frequency search with an RMS solver.

For fast, effective bonding, the MEH sonotrode has a dual-vibration sonotrode that provides two separate orthogonal vibrations to a contact surface to ensure perfect bonding in terms of material characterization. Such perfect bonding is important in, for example, aerospace-class quality and certification.

The present disclosure relates to the art and science of a 3D printing technology or AM technology, in particular, Scalable Multiple-Material Additive Manufacturing (SMAM). It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for fabricating an object by adding multiple types of materials incrementally point-by-point and layer-by-layer by a three-dimensional (3D) printer, the method comprising:
calibrating feedstock feeders;
calibrating a bonding wedge level and a raft-base plate level;
positioning a multi-functional ensemble head (MEH) at a start position with respect to a raft-base plate coupled to a reusable base platen;
supplying a feedstock segment without cutting to a bonding wedge under a guiding path;
applying ultrasonic energy in a range of about 20 k to about 200 k Hz to the start position to print a first point on the raft-base plate;
applying a weak normal force in a range of about 0.001 N to 10 N to bonding wedges without causing excessive compression on a feedstock material;
printing a first layer on the raft-base plate by printing point-by-point on the first point;
adjusting a level and a frequency of the ultrasonic energy based on a type and a property of the feedstock material for multiple, dissimilar material printing;
moving the MEH to a next position after printing the first layer;
applying ultrasonic energy to the next position to print a next point bonded with the first layer;
printing a second layer by printing point-by-point on the next point;
repeating moving the MEH to a next position and applying ultrasonic energy to the next position to print point-by-point and layer-by-layer until all layers are printed on the raft-base plate; and
performing post-processing, comprising heat treatment and deburring/surf ace-finishing, on the printed object when printing on a last point of a last layer is completed,
wherein each of the feedstock feeders contains a different type of feedstock material.

2. The method of claim 1, further comprising:
sensing tension and control;
sensing a status of the feedstock material and calculating remaining amounts of the feedstock material; and
dispensing multiple different wire feedstocks,
wherein:
wires in a range of 10 μm to 1 cm in diameter are handled with a set of self-adjusting drive wheel;
the wires are fed at a correct force to avoid damaging the wires;
an adequate force is provided to grip a microwire having a smaller diameter for continuous operation; and
a feed rolls is placed close to the wedges to avoid bucking caused by an axial loading condition and poor strength of the microwire.

3. The method of claim 1, wherein the calibration of the bonding wedge level is performed automatically with multiple cameras by image processing.

4. The method of claim 1, further comprising:
lifting the MEH to a preset height prior to moving the MEH to the next position; and
adjusting the preset quality parameters for best atomic bonding.

5. The method of claim 1, wherein the raft-base plate is removable from the base platen.

6. The method of claim 1, further comprising cutting away the raft-base plate for part removal after the printing is completed.

7. The method of claim 1, further comprising:
a print-and-cut mode for moving the MEH to the next position without printing at a current position by activating a cutting blade; and
a continuous-point mode in which ultrasonic energy is applied continuously point-wise without feedstock cutting.

8. The method of claim 1, further comprising feeding a Computer Aided Design (CAD) file directed to a target object corresponding to the object to the 3D printer.

9. The method of claim 1, wherein:
the ultrasonic energy is amplified through a sonotrode;
a normal force feedback control is applied to control a magnitude of normal force in order to achieve lossless ultrasonic energy transfer and to compensate a frequency shift when the normal force is applied;
the normal force feedback control governs a firm, clean bonding with a very small normal force; and
a force of less than 1 N is enough with the normal force feedback control for a thin wire of about 100 micron.

10. The method of claim 9, wherein:
the sonotrode is coupled to a bonding wedge;
a tip of the bonding wedge comprises variants, each tip having a different function and shape;
the variants comprise a rectangular contact surface, a wire-feeding groove for typical wire feedstock, a grooved rectangular tip preventing potential surface slips, and a continuous printing tip with smooth-edges useful for continuous printing without ripping or denting feedstocks;
the groove shape has variants comprising linear, circular, zigzag, and chevron; the bonding wedge is configured as a circular or rectangular bottom surface; and
the bonding wedge has a concentric feedstock path to change the printing direction more freely without wrinkle or kink on a being-fed segment.

11. The method of claim 10, wherein the bonding wedge is coupled to the sonotrode vertically.

12. The method of claim 10, wherein the bonding wedge is coupled to the sonotrode horizontally.

13. The method of claim 10, wherein:
the bonding wedge comprises two bonding wedges or duplex wedges; and
the bonding wedge comprises a roller type bottom surface with a circular wire guiding groove, the roller type bottom surface having a cylindrical shape and rolls along the fed feedstock segment.

14. The method of claim 13, wherein:
the duplex wedges are coupled to an end portion of the sonotrode, each of the duplex wedges comprising a cutting blade; and
the cutting blade's cutting direction is horizontal or vertical against the fed segment.

15. The method of claim 13, wherein:
each wedge comprises two separate bonding surfaces for application of the ultrasonic energy;
a bonding surface that applies ultrasonic energy for a new point; and
a strengthening surface that applies ultrasonic energy to bonded lateral and horizontal interfaces to remove a void or flaw.

16. The method of claim 13, wherein:
a first wedge of the duplex wedges is used for printing metallic material and a second wedge of the duplex wedges is used for printing polymer support material;
the duplex wedge is configured to print two different class materials seamlessly by slightly rotating the MEH without changing the MEH's printing head; and
the MEH is configured to rotate to avoid interfering with a path of the first wedge or hindering printing when the second wedge is activated.

17. The method of claim 16, wherein:
power of the ultrasonic energy is stronger for the first wedge than the second wedge; and
the first wedge uses a 3-way manifold to connect each independently-controlled microwire feeding mechanism such that at least three different types of materials are fed.

18. The method of claim 1, wherein the bonding of the next point with the first layer and bonding of a subsequent point with a subsequent layer is a solid state bonding without any melting.

19. The method of claim 13, wherein:
a sonotrode configuration generates dual directional vibrations whose motion direction is orthogonal; and
a vertical or horizontal configuration of two sets of ultrasonic transducers are controlled by sending electrical signals.

20. A system for scalable multiple-material additive manufacturing (SMAM) comprising:
an on-demand multiple material manufacturing (M3) unit configured to additively print a designed object, the M3 unit comprising a multi-functional ensemble head (MEH) configured for multiple material printing, in-line metrology, in-line error corrective milling, and in-line quality inspection;
a process control unit (PCU) configured to autonomously control all functions of the system with remote operation interfaces;
an expandable post-processing unit configured to perform heat treatment and polishing/deburring, following the printing;
an environmental control unit including an oxygen removal system and particulate filters for additive manufacturing and post-processing;
a protective housing providing structural stability and vibration isolation with power and electrical interfaces;
a printing head assembly comprising a plurality of printing heads with a multiple feeding mechanism;
a laser scanning metrology to monitor dimension discrepancy within a tolerance; and
an in-line nondestructive evaluation inspection configured to find interfacial defects during the printing.

21. The system of claim 20, wherein the PCU is further configured to:
cause a milling tool of the M3 unit to correct dimensional discrepancies by on the printing head assembly;
intervene to correct inconsistencies using the milling tool when a dimension discrepancy or a flaw is identified; and
cause the printing head assembly to print an additional portion as calculated when additional materials are required according to measurement,
wherein the printing head assembly is integrated with a multiple material feeder in a single head unit configured as the MEH.
